(19) United States
(12) Patent Application Publication
(10) Pub. No.: US 2014/0351362 A1
(43) Pub. Date: Nov. 27, 2014

(54) COMPUTER SYSTEM, DATA TRANSFER METHOD, AND DATA TRANSFER PROGRAM

(71) Applicants: Yusuke Shirakami, Tokyo (JP); Momoko Ohshita, Tokyo (JP)

(72) Inventors: Yusuke Shirakami, Tokyo (JP); Momoko Ohshita, Tokyo (JP)

(73) Assignee: HITACHI, LTD., Tokyo (JP)

(21) Appl. No.: 14/353,749

(22) PCT Filed: Nov. 2, 2011
(86) PCT No.: PCT/JP2011/075321

§ 371 Date: Jul. 24, 2014

(51) Int. Cl. H04L 29/08; H04L 12/707

(52) U.S. Cl. CPC H04L 67/1097; H04L 45/22
USPC 709/213

(57) ABSTRACT

Execution servers including a first execution server store data output by executing jobs to storage devices including semiconductor memory elements. A management server holds input/output information including identifiers identifying pieces of data, identifiers identifying execution servers which output the pieces of data, and identifiers identifying execution servers to execute jobs which receive the pieces of data. The first execution server sends a destination request including identifiers identifying the first execution server and a first piece of data to the management server. The management server determines an execution server to execute a job which receives the first piece of data to be a destination execution server of the first piece of data based on the input/output information and the received destination request, and outputs a transfer instruction for transferring the first piece of data from the storage device holding the first piece of data to the determined destination execution server.

### BACKGROUND

This invention relates to a computer system and, in particular, relates to a computer system for executing jobs.

In order to perform a plurality of different processing phases speedily and reliably, cluster systems composed of multiple computers are widely employed at present.

To perform a plurality of different processing phases by a plurality of jobs in a traditional cluster system, the administrator schedules which computer to execute which job in order to allocate computer resources to the jobs. More specifically, the administrator schedules which computer to execute a job to be executed first (preceding job) and which computer to execute a job to be executed next (subsequent job).

When some data is output by a preceding job, the computer to execute the subsequent job acquires this output data and inputs the output data to the subsequent job. Thus, the computer to execute the subsequent job executes the subsequent job.

A traditional method employed to input data output by a preceding job to a subsequent job to be executed by a different computer is that the preceding job outputs data to a disk device shared by a plurality of computers and the subsequent job retrieves the data output by the preceding job from the disk device.

In the meanwhile, a technique has been proposed that mirrors storage areas of disk devices of a plurality of computers with one another for the plurality of computer to share data (for example, refer to Patent Literature 1).

Furthermore, there is a practical technique that configures a memory (primary storage device) included in a shared I/O server of a shared file system as a temporary buffer area to store data output by a preceding job. In using this technique, the computer to execute the subsequent job acquires data from the memory in the shared I/O server.

Patent Literature 1: JP 2008-225643 A

### SUMMARY

In scheduling data-linked jobs in which a preceding job sends data to a subsequent job to serially execute a plurality of jobs, traditional cluster systems have the following two problems.

The first problem is that, in the case where a preceding job outputs data to a disk device shared by computers or a disk device to be mirrored among computers, the performance of the disk device significantly degrades because of the overhead of the disk device. If the cluster system executes a plurality of series of data-linked jobs concurrently, the performance degradation of the disk device causes delay in the subsequent jobs.

The second problem is that, in the case of using the memory of a shared I/O server, the capacity of the memory is extremely small compared with the size of output data. Accordingly, it is difficult to store massive data in the memory without restriction. Furthermore, the computer to execute the subsequent job might acquire data output by a different job from the memory of the shared I/O server.

An object of this invention is to provide a technique to input data output by a job to another job to be executed by a different computer without performance degradation of the disk device or tight usage of the memories in the computers.

A representative embodiment of this invention is a computer system including a plurality of execution servers, and a management server connected with the plurality of execution servers via a network. Each of the plurality of execution servers includes a processor and a network interface. Each of the plurality of execution servers stores pieces of data output by executing jobs to a storage device including semiconductor memory elements. The plurality of execution servers includes a first execution server. The management server includes a processor, a memory, and a network interface. The management server holds input/output information including identifiers identifying pieces of data, identifiers identifying execution servers which output the pieces of data, and identifiers identifying execution servers to execute jobs to which the pieces of data are input in the memory of the management server. The first execution server sends a request for destination including an identifier identifying the first execution server and an identifier identifying a first piece of data, which is output by executing a job in the first execution server to the management server in order to inquire where to transfer the first piece of data. The management server which has received the request for destination determines an execution server to execute a job to which the first piece of data is input to be a destination execution server of the first piece of data based on the input/output information and the received request for destination. The management server outputs an instruction for transfer including an identifier identifying the determined destination execution server and the identifier identifying the first piece of data in order to transfer the first piece of data from the storage device holding the first piece of data to the determined destination execution server.

According to an exemplary embodiment of this invention, data output by a job can be sent to another job to be executed by a different computer without performance degradation of the disk device.

### BRIEF DESCRIPTION OF THE DRAWINGS

FIG. 1 is a block diagram illustrating a physical configuration of a computer system in the first embodiment of this invention;

FIG. 2 is an explanatory diagram illustrating a data location management table in the first embodiment of this invention;

FIG. 3 is an explanatory diagram illustrating a job input/output management table in the first embodiment of this invention;

FIG. 4 is an explanatory diagram illustrating a memory usage management table in the first embodiment of this invention;

FIG. 5 is a flowchart illustrating file transfer performed by a file operator in the first embodiment of this invention;

FIG. 6 is a flowchart illustrating history information analysis in the first embodiment of this invention;

FIG. 7 is a block diagram illustrating a physical configuration of a computer system in the second embodiment of this invention;

FIG. 8 is a flowchart illustrating file transfer performed by a file operator in the second embodiment of this invention;

FIG. 9 is a block diagram illustrating a physical configuration of a computer system in the third embodiment of this invention; and

FIG. 10 is a flowchart illustrating file transfer performed by a file operator and a job scheduler communication part in the second embodiment of this invention.

### DETAILED DESCRIPTION OF THE EMBODIMENTS

Computer systems in the embodiments of this invention hold information specifying the computers to receive files output by preceding jobs so that the file management server can determine where to transfer the files. Consequently, each computer can transfer a file output by a preceding job to another computer to receive the file without using a disk device.

### First Embodiment

Hereinafter, the first embodiment to implement this invention will be described.

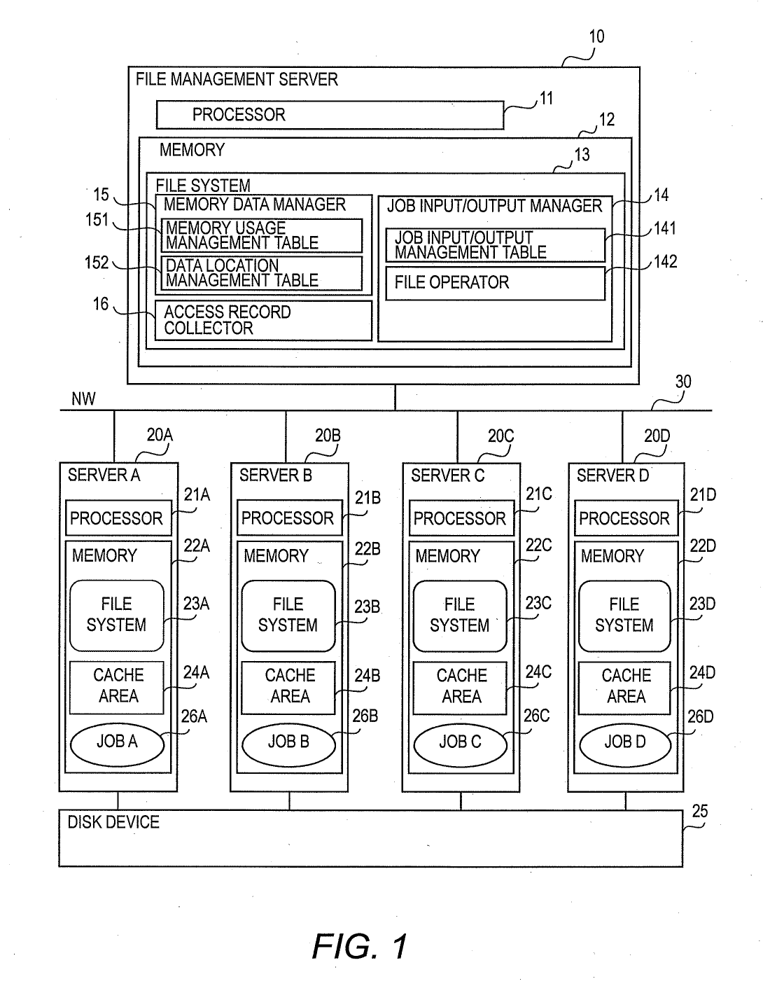

FIG. 1 is a block diagram illustrating a physical configuration of a computer system in the first embodiment of this invention.

The computer system in this embodiment includes a file management server 10 and a plurality of servers 20 (20A to 20D). The file management server 10 and the servers 20 are connected by a network 30.

Each server 20 is a computer for executing a job. The file management server 10 is a computer for determining where to transfer each file output by jobs 26.

The file management server 10 is a computer for collecting information about the jobs and includes a processor 11 and a memory 12. Furthermore, it includes a not-shown network interface to connect with the network 30.

The processor 11 is an arithmetic device such as a CPU. The processor 11 loads programs to the memory 12 and executes the programs on the memory 12. Furthermore, the processor 11 retrieves data to the memory 12 as required by the program to be executed.

The memory 12 is a storage area for temporarily holding programs or data. The memory 12 is used as a primary storage device.

The memory 12 holds a file system 13. The file system 13 is a program for extracting data to be stored in the memory 12 in units of files and making programs process the data as files. The processor 11 in this embodiment uses the file system 13 to execute programs.

The memory 12 holds a job input/output manager 14, a memory data manager 15, and an access record collector 16. The processor 11 in this embodiment uses the file system 13 of the file management server 10 to execute the job input/output manager 14, the memory data manager 15, and the access record collector 16.

The job input/output manager 14 is a program for collecting information on files output by jobs 26 executed by the servers 20 and files input to jobs 26 executed by the servers 20 and holding the collected information. The job input/output manager 14 holds a job input/output management table 141. It also calls up a file operator 142 as necessary.

The job input/output management table 141 is a table for holding information on files output by jobs 26 executed by the servers 20 and files input to jobs 26 executed by the servers 20. The file operator 142 is a program for instructing servers 20 that have executed jobs 26 where to transfer the files output by the jobs 26.

The memory data manager 15 is a program for collecting information on usages of the memories 22 in the servers 20 and information indicating the servers 20 holding the files output by the jobs 26 and holding the collected information. The memory data manager 15 holds a memory usage management table 151 and a data location management table 152.

The memory usage management table 151 is a table for holding information indicating the usages of memories 22 of the servers 20. The data location management table 152 is a table for holding information indicating the servers 20 holding the files output by the jobs 26.

The access record collector 16 is a program for collecting records of accesses from the servers 20 to the files containing history information among the files output by the jobs 26. The access record collector 16 periodically collects the records of accesses from the servers 20 to the files.

Each of the aforementioned programs held by the file management server 10 may be implemented by a plurality of physical processing units including a processor. Each program may perform the processing by calling up a plurality of programs for different processing phases included in the program. The functions of the aforementioned programs may be implemented in the file management server 10 as a single program for executing the aforementioned programs.

The tables held by the file management server 10 may hold information in any form, as far as the programs can uniquely identify the information. For example, the information may be held in the CSV format.

The programs and tables held by the memory 12 may be installed to the memory 12 through a program distribution server or a computer-readable non-transitory storage medium. Alternatively, they may be held in a non-volatile storage device (not shown) included in the file management server 10 to be loaded to the memory 12 as necessary.

Each server 20 is a computer for executing a job 26 and includes a processor 21 (one of 21A to 21D) and a memory 22 (one of 22A to 22D). Each server 20 further includes a not-shown network interface for connecting with the network 30. The servers 20 are connected with a disk device 25.

FIG. 1 shows only four servers 20 but the computer system of this embodiment may include any number of servers 20.

The processor 21 is an arithmetic device such as a CPU. The processor 21 loads programs to the memory 22 and executes the programs on the memory 22.

The memory 22 is a storage area for temporarily storing programs and data. The memory 22 is used as a primary storage device. The memory 22 holds a file system 23 (one of 23A to 23D) and a job 26 (one of 26A to 26D). The memory 22 includes a cache area 24 (one of 24A to 24D).

The cache area 24 is a part of the area of the memory 22.

The file system 23 is a program for extracting data to be stored in the memory 22 in units of files and making programs process the data as files. The processor 21 in this embodiment uses the file system 23 to execute programs included in the job 26.

The processor 21 in this embodiment uses the file system 23 to store data output by a job 26 in the cache area 24 as files.

The job 26 includes a program and parameters to be used by the program and is executed by the processor 21. The server 20A executes the job 26A; the server 20B executes the job 26B; the server 20C executes the job 26C; and the server 20D executes the job 26D.

In this embodiment, data output by the job 26 is processed as a file owing to the file system 23; however, as far as the program can process the data as a piece of data, the data may be processed in any form other than that of the file system 23.

The disk device 25 is a storage area for holding programs and data. The disk device 25 is shared by the servers 20.

The network 30 is a network for connecting the servers 20 and may include a network device such as a switch.

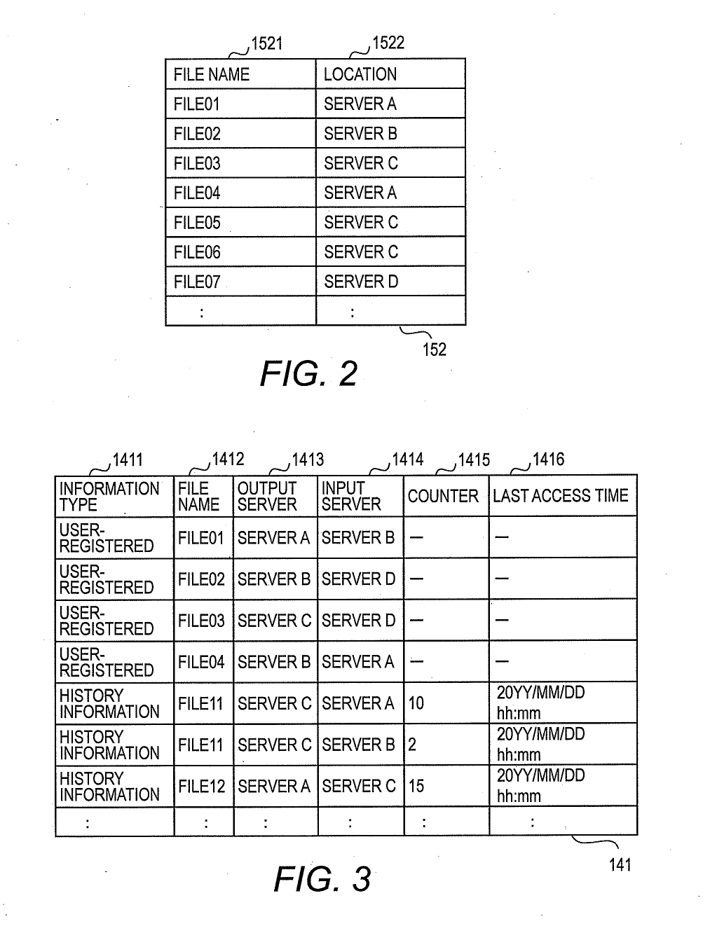

FIG. 2 is an explanatory diagram illustrating the data location management table 152 in the first embodiment of this invention.

The data location management table 152 is a table indicating which server 20 holds which file output by executed jobs 26. The data location management table 152 includes file names 1521 and locations 1522.

The file names 1521 include identifiers identifying the files output from executed jobs 26. The file names 1521 may include any values such as numbers or letters as far as they include values uniquely identifying the files.

The locations 1522 include identifiers identifying servers 20. The locations 1522 may include any values such as numbers or letters as far as they include values uniquely identifying the servers 20.

The data location management table 152 is updated by the memory data manager 15 after determination of the destination to transfer a file through later-described processing of the file operator 142.

FIG. 3 is an explanatory diagram illustrating the job input/output management table 141 in the first embodiment of this invention.

The job input/output management table 141 indicates which server 20 performed the preceding job that output a file and which server 20 is to perform the subsequent job to which the file is input. The job input/output management table 141 includes information types 1411, file names 1412, output servers 1413, input servers 1414, counters 1415, and last access times 1416.

The information types 1411 indicate the types of files. The information types 1411 in this embodiment include identifiers identifying either user-registered information or history information. The user-registered information in this embodiment is information prepared by the user to input to a job.

The history information in this embodiment is information created based on records of accesses from jobs 26 to a file. A file containing history information may be accessed by a plurality of jobs 26 executed by different servers 20.

The file names 1412 contain identifiers identifying files. The file names 1412 in the job input/output management table 141 correspond to the file names 1521 in the data location management table 152.

The job input/output management table 141 shown in FIG. 3 identifies data output by jobs 26 with file names. Consequently, the administrator in this embodiment can easily edit the job input/output management table 141.

Even if the servers 20 do not have file systems 23, however, the job input/output management table 141 may include any values as far as they include identifiers for uniquely identifying data output by the jobs 26.

The output servers 1413 include identifiers identifying the servers 20 that executed the jobs 26 from which the files were output. In other words, the output servers 1413 indicate the servers 20 that executed preceding jobs.

The input servers 1414 include identifiers identifying the servers 20 to execute the jobs 26 to which the files are to be input. In other words, the input servers 1414 indicate the servers 20 to execute subsequent jobs.

The output servers 1413 and the input servers 1414 in the job input/output management table 141 correspond to locations 1522 in the data location management table 152.

The counters 1415 indicate how many times the servers 20 identified by the input servers 1414 accessed the files identified by the file names 1412. The last access times 1416 indicate the times when the servers 20 identified by the input servers 1414 last accessed the files identified by the file names 1412. As to the counters 1415 and the last access times 1416, values are stored in only the entries in which the information types 1411 indicate history information.

As to the entries in which the information types 1411 indicate user-registered information, the values stored in the file names 1412, the output servers 1413, and the input servers 1414 are entered in advance by the administrator. As to the entries in which the information types 1411 indicate history information, at least the values stored in the file names 1412 and the output servers 1413 are entered in advance by the administrator and the values stored in the input servers 1414 may also be entered in advance by the administrator.

As to the entries in which the information types 1411 are history information, the information on accesses in the counters 1415 and the last access times 1416 are updated by the access record collector 16. Hereinafter, a method of collecting information on accesses by the access record collector 16 is described.

When starting a job 26, a server 20 sends the file management server 10 a request for storage location to inquire the location storing the file to be input to the job 26 to be executed. The request for storage location includes at least the identifier of the file and the identifier of the server 20 sending the request for storage location.

Upon receipt of a request for storage location from a server 20, the memory data manager 15 in the file management server 10 extracts an entry of the data location management table 152 including the identifier of the file designated in the request for storage location in the file name 1521. The location 1522 of the extracted entry indicates the server 20 storing the file designated in the request for storage location. Accordingly, the file operator 142 instructs the server 20 identified by the location 1522 of the extracted entry to transfer the file designated in the request for storage location to the server 20 that sent the request for storage location.

At this time, the access record collector 16 extracts an entry of the job input/output management table 141 including the identifier of the file designated in the request for storage location in the file name 1412 and the identifier identifying the server 20 that sent the request for storage location in the input server 1414. If an entry is extracted and the information type 1411 of the entry indicates history information, the access record collector 16 adds 1 to the value held in the counter 1415 of the extracted entry. Further, it updates the last access time 1416 of the extracted entry with the time the request for storage location was sent from the server 20.

Through these operations, the access record collector 16 updates the information on accesses to a file containing history information. If extracted from the job input/output management table 141 is only the entry in which the file name 1412 is the identifier of the file designated in the request for storage location and the information type 1411 is history information, the access record collector 16 may add a new entry to the job input/output management table 141.

Specifically, the access record collector 16 may store a value indicating history information to the information type 1411, the identifier of the file designated in the request for storage location to the file name 1411, and the identifier identifying the server 20 that sent the request for storage location to the input server 1414 of the newly added entry. Furthermore, the access record collector 16 may store a value of the output server 1413 in the extracted entry to the output server 1413, a value 1 to the counter 1415, and the time the request for storage location sent from the server 20 to the last access time 1416 of the newly added entry.

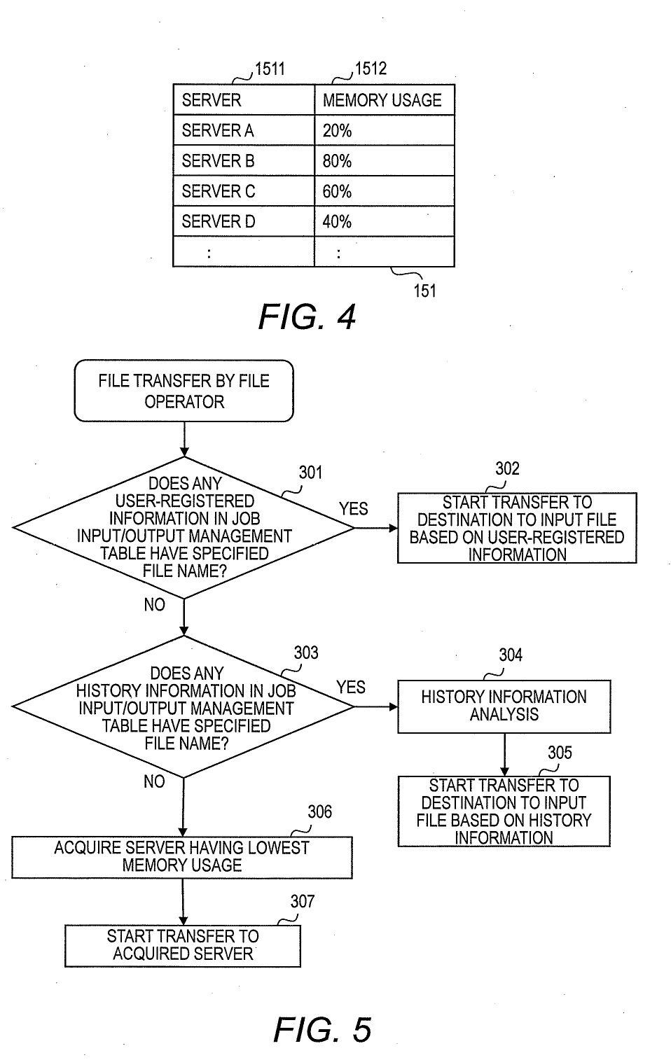

FIG. 4 is an explanatory diagram illustrating the memory usage management table 151 in the first embodiment of this invention.

The memory usage management table 151 indicates usages of the memories 22 in the servers 20. The memory usage management table 151 includes servers 1511 and memory usages 1512.

The servers 1511 include identifiers identifying servers 20. The servers 1511 in the memory usage management table 151 correspond to the locations 1522 in the data location management table 152. The memory usages 1512 indicate usages of the memories 22 in the servers 20.

The memory data manager 15 collects usages of the memories 22 from the servers 20 periodically or in accordance with an instruction from the administrator or a user. The values stored in the memory usage management table 151 are updated by the memory data manager 15 with the values indicating usages of the memories 22 collected from the servers 20.

Furthermore, the file system 23 in each server 20 acquires the usage of the memory 22 every time a file is output to the cache area 24 after execution of a job 26 and sends the acquired usage of the memory 22 to the file management server 10. The memory data manager 15 updates the memory usage 1512 with the received usage of the memory 22 of the server 20.

FIG. 5 is a flowchart illustrating file transfer performed by the file operator 142 in the first embodiment of this invention.

FIG. 5 illustrates processing of the file operator 142 to determine where to transfer a file output by a job 26.

In each server 20, the file system 23 stores a file output by the job 26 to the cache area 24 after execution of the job 26. Then, in order to inquire where to transfer the output file, it sends a request for information on the destination (request for destination) and the usage of the memory 22 to the file management server 10. The request for destination includes at least the identifier of the server 20 sending the request for destination and the identifier of the output file.

Upon receipt of a request for destination from a server 20, the file management server 10 starts the processing illustrated in FIG. 5. First, the file operator 142 that has received a request for destination from a server 20 refers to the job input/output management table 141. Then, the file operator 142 determines whether any entry of the job input/output management table 141 can be extracted in which the information type 1411 indicates user-registered information and the file name 1412 and the output server 1413 respectively include the identifier of the file designated by the request for destination and the identifier of the server that sent the request for destination (301).

If the determination at Step 301 is that an entry of the job input/ output management table 141 can be extracted in which the information type 1411 indicates user-registered information and the file name 1412 and the output server 1413 respectively include the identifier of the file designated by the request for destination and the identifier of the server that sent the request for destination, the file designated by the request for destination is predetermined to be transferred to the server 20 indicated by the input server 1414 of the extracted entry. Accordingly, the file operator 142 determines that the server 20 indicated by the input server 1414 of the entry extracted at Step 301 is the destination of the file designated by the request for destination.

The file operator 142 sends an instruction for transfer including the identifier identifying the determined destination and the identifier identifying the file designated by the request for destination (which is the file to be transferred) to the server 20 which sent the request for destination. Upon receipt of the instruction for transfer, the file system 23 of the server 20 transfers the file stored in the cache area 24 to the determined destination server 20 in accordance with the received instruction for transfer (302).

Further at Step 302, the memory data manager 15 acquires the identifier identifying the destination of the file from the file operator 142. Then, it extracts an entry of the data location management table 152 that includes the identifier identifying the transferred file in the file name 1521 and updates the location 1522 of the extracted entry with the identifier identifying the destination server 20.

If the determination at Step 301 is that no entry of the job input/output management table 141 can be extracted in which the information type 1411 indicates user-registered information and the file name 1412 and the output server 1413 respectively include the identifier of the file designated by the request for destination and the identifier of the server that sent the request for destination, the file operator 142 determines whether any entry of the job input/output management table 141 can be extracted in which the information type 1411 indicates history information and the file name 1412 and the output server 1413 respectively include the identifier of the file designated by the request for destination and the identifier of the server 20 that sent the request for destination (303).

If the determination at Step 303 is that an entry of the job input/output management table 141 can be extracted in which the information type 1411 indicates history information and the file name 1412 and the output server 1413 respectively include the identifier of the file designated by the request for destination and the identifier of the server 20 that sent the request for destination, the file operator 142 performs history information analysis (304). This is because to which server 20 to transfer the file should be determined since a file containing history information may be referred to by a plurality of servers 20.

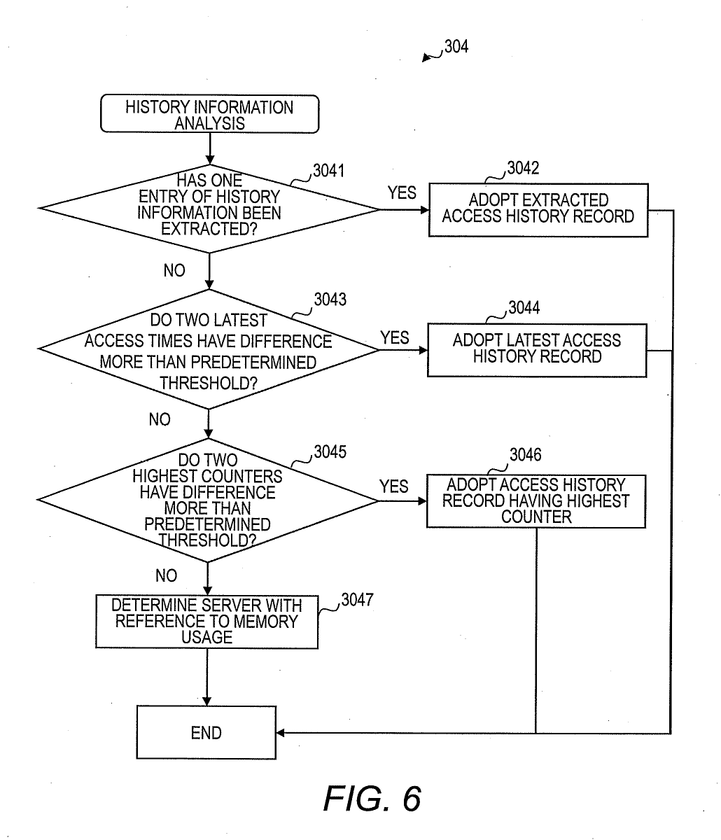

Through the history information analysis, the destination of the file is determined. The details of the history information analysis will be described later with FIG. 6.

After Step 304, the file operator 142 sends an instruction for transfer including the identifier identifying the determined destination and the identifier identifying the file to be transferred to the server 20 that sent the request for destination. Upon receipt of the instruction for transfer, the file system 23 of the server 20 transfers the file stored in the cache area 24 to the destination server 20 in accordance with the received instruction for transfer (305).

Further at Step 305, the memory data manager 15 acquires the identifier identifying the destination of the file from the file operator 142. Then, it extracts an entry of the data location management table 152 including the identifier identifying the transferred file in the file name 1521 and updates the location 1522 of the extracted entry with the identifier of the destination server 20.

If the determination at Step 303 is that no entry of the job input/output management table 141 can be extracted in which the information type 1411 indicates history information and the file name 1412 and the output server 1413 respectively include the identifier of the file designated by the request for destination and the identifier of the server 20 that sent the request for destination, the file operator 142 cannot determine the destination of the file based on the job input/output management table 141. Accordingly, the file operator 142 refers to the memory usage management table 151 and acquires a value of the server 1511 of the entry in which the memory usage 1512 indicates the lowest value (306).

After Step 306, the file operator 142 determines the destination of the file designated by the request for transfer to be the server 20 identified by the server 1511 acquired at Step 306. The file operator 142 sends an instruction for transfer including the identifier identifying the determined destination and the identifier identifying the file to be transferred to the server 20 that sent the request for destination.

Upon receipt of the instruction for transfer, the file system 23 of the server 20 transfers the file stored in the cache area 24 to the destination server 20 in accordance with the received instruction for transfer (307). Through this operation, a file to which job 26 to be input is not determined is stored in the memory 22 of the server 20 having the lowest memory usage, so that the memories 22 of the servers 20 included in the computer system of this embodiment can be prevented from becoming tight.

Further at Step 307, the memory data manager 15 acquires the identifier identifying the destination of the file from the file operator 142. Then, it extracts an entry of the data location management table 152 including the identifier of the transferred file in the file name 1521 and updates the location 1522 of the extracted entry with the identifier of the destination server 20.

Through the processing illustrated in FIG. 5, each file output by the jobs 26 can be transferred to the server 20 to execute the job 26 of the subsequent job not via the shared disk device 25. Hence, the I/O for the disk device 25 can be reduced.

If the destination server 20 does not have a job 26 to receive the transferred file as an input file, the destination server 20 stores the transferred file in the cache area 24. If any server 20 wants to perform a job 26 with input data of a file held in a different server 20, it sends an above-described request for storage location to the file management server 10.

Since the file is held in the server 20 having a low memory usage until execution, the computer system of this embodiment can prevent the file output by a job 26 from tightening the usages of the memories 22.

FIG. 6 is a flowchart illustrating history information analysis in the first embodiment of this invention.

If the determination at Step 303 is that an entry of the job input/output management table 141 can be extracted in which the information type 1411 indicates history information and the file name 1412 and the output server 1413 respectively include the identifier of the file designated by the request for destination and the identifier identifying the server 20 that sent the request for destination, the history information analysis at Step 304 is performed.

In the history information analysis, the file operator 142 extracts entries in which the file names 1412 indicate the identifier of the file included in the request for destination and the output servers 1413 indicate the server 20 that sent the request for destination and determines whether the number of extracted entries is one (3041). If the determination at Step 3041 is that the number of extracted entries is one, the file operator 142 determines the server 20 indicated by the input server 1414 of the extracted entry to be the destination server 20 (3042).

If the determination at Step 3041 is that the number of extracted entries is two or more, the file operator 142 refers to the last access times 1416 of the extracted entries. Then, the file operator 142 calculates the difference between the last access time 1416 closest to the current time and the last access time 1416 second closest to the current time among the extracted entries. Then, the file operator 142 determines whether the calculated difference is more than a predetermined threshold held in advance (3043).

If the determination at Step 3043 is that the calculated difference is more than the predetermined threshold, the file operator 142 identifies the entry including the last access time 1416 closest to the current time among the entries extracted at Step 3041. The file operator 142 determines the server 20 indicated by the input server 1414 of the identified entry to be the destination server 20. This is because the server 20 having the last access time 1416 outstandingly close to the current time compared with the other servers 20 has a high possibility to execute the job 26 to input the file.

If the determination at Step 3043 is that the calculated difference is the predetermined threshold or less, the file operator 142 refers to the counters 1415 of the entries extracted at Step 3041. Then, the file operator 142 calculates the difference between the highest counter value 1415 and the second highest counter value 1415 among the extracted entries. Then, the file operator 142 determines whether the calculated difference is more than the predetermined threshold held in advance (3045).

If the determination at Step 3045 is that the calculated difference is more than the predetermined threshold, the file operator 142 identifies the entry including the highest counter value 1415 among the entries extracted at Step 3041. Then, the file operator 142 determines the server 20 indicated by the input server 1414 of the identified entry to be the destination server 20. This is because the server 20 that accessed the file outstandingly frequently compared with the other servers 20 has a high possibility to execute the job 26 to input the file.

If the determination at Step 3045 is that the calculated difference is the predetermined threshold or less, the file operator 142 refers to the memory usage management table 151 and acquires the value of the server 1511 of the entry in which the memory usage 1512 shows the lowest value. The file operator 142 determines the server 20 identified by the acquired value 1511 to be the destination server 20.

The foregoing history information analysis enables the computer system in this embodiment to transfer a file containing history information output by a job 26 to a server 20 having a highest possibility to need the file as an input file.

According to the first embodiment, a file output by a job 26 can be transferred to the server 20 to perform a job 26 of the subsequent job without using the shared disk device 25. For this reason, the I/O for the disk device 25 can be reduced. As a result, neither the performance of the disk device 25 is degraded nor the memories 22 included in the servers 20 become tight.

The job input/output management table 141 enables a file accessed by a multiple servers 20 to be transferred to the server 20 having the highest possibility to need the file as an input file.

The file management server 10 in the first embodiment collects the usages of the memories 22 of the servers 20 to determine to transfer a file output by a job 26 for which the destination cannot be determined with the job input/output management table 141 to the server 20 having the lowest usage of the memory 22. This approach can prevent the file output by the job 26 from tightening the memories 22 of the servers 20 included in the computer system in this embodiment.

### Second Embodiment

The computer system in the second embodiment uses an SSD and a PCIe switch, instead of a disk device 25, to input a file output from a job 26 of a preceding job to a job of a subsequent job. Furthermore, it can reduce the load to the memories 22.

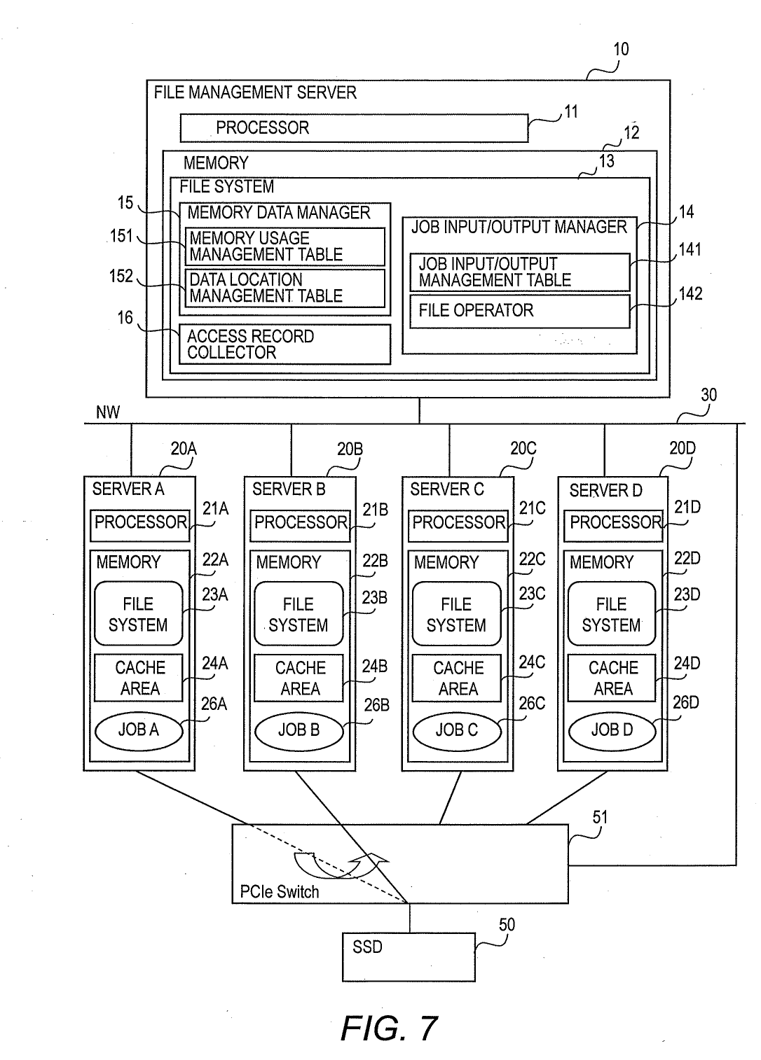

FIG. 7 is a block diagram illustrating a physical configuration of a computer system in the second embodiment of this invention.

The computer system in the second embodiment includes a file management server 10 and a plurality of servers 20 (20A to 20D) like in the first embodiment. The file management server 10 and the servers 20 are connected by a network 30.

The servers 20 in the second embodiment are the same as the servers 20 in the first embodiment. However, the servers 20 in the second embodiment are different from the servers 20 in the first embodiment in the point that they are connected with a PCIe switch (PCI Express Switch) 51. The PCIe switch 51 is further connected with an SSD (Solid State Drive) 50. However, the servers 20 in the second embodiment may be connected with the disk device 25 in the first embodiment.

The servers 20 in the second embodiment share the SSD 50 using the PCIe switch 51. The PCIe switch 51 switches the destinations to output the files stored in the SSD 50 to switch the ownerships of the files stored in the SSD 50.

The file management server 10 in the second embodiment is the same as the file management server 10 in the first embodiment. However, the file operator 142 in the second embodiment is different from the file operator 142 in the first embodiment in the point that, after determination of the destination server 20, the file operator 142 instructs the PCIe switch 51 to switch to the determined destination server 20.

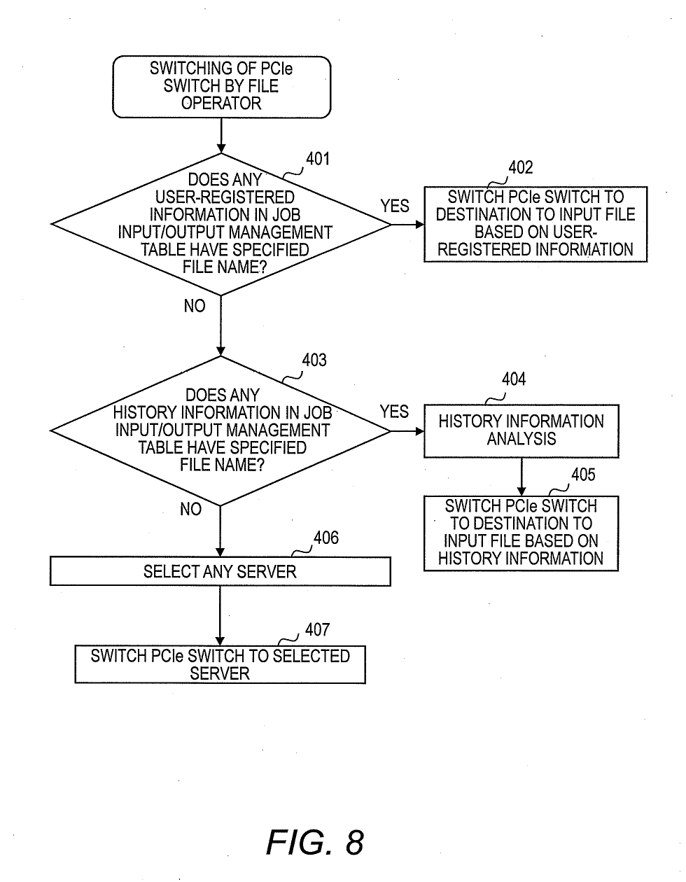

FIG. 8 is a flowchart illustrating file transfer performed by the file operator 142 in the second embodiment of this invention.

In each server 20 in the second embodiment, the file system 23 stores, after execution of a job 26, a file output by the job 26 to the SSD 50 of the server 20 that executed the job 26 (namely, the source server 20). Then, the file system 23 sends a request for destination and the usage of the memory 22 to the file management server 10 to inquire where to transfer the output file, like the file system 23 in the first embodiment.

Upon receipt of a request for destination from a server 20, the file management server 10 in the second embodiment starts the processing illustrated in FIG. 8. First, like the file operator 142 in the first embodiment, the file operator 142 in the second embodiment that has received a request for destination from the server 20 determines whether any entry of the job input/output management table 141 exists in which the file name 1412 indicates the file included in the request for destination and the output server 1413 indicates the server 20 included in the request for destination among the entries in which the information types 1411 indicate user-registered information (401).

If the determination at Step 401 is that an entry of the job input/output management table 141 exists in which the file name 1412 indicates the file included in the request for destination and the output server 1413 indicates the server 20 included in the request for destination among the entries in which the information types 1411 indicate user-registered information, the file operator 142 determines the server 20 indicated by the input server 1414 of the entry representing the file included in the request for destination to be the destination of the file.

The file operator 142 in the second embodiment sends an instruction for transfer including the identifier identifying the determined destination and the identifier identifying the file to be transferred to the PCIe switch 51. Upon receipt of the instruction for transfer, the PCIe switch 51 switches the ownership of the file stored in the SSD 50 to the destination server 20 designated by the received instruction for transfer (402). Specifically, the PCIe switch 51 switches the destination to output the file stored in the SSD 50 to the destination server 20 designated by the received instruction for transfer. As a result of this operation, the file output by the job 26 is acquired by the destination server 20.

Further at Step 402, the memory data manager 15 stores the identifier identifying the file for which the destination has been determined to the file name 1521 in the data location management table 152 and the identifier identifying the destination server 20 to the location 1522 in the data location management table 152, like at Step 302 in the first embodiment. In the meanwhile, when the file operator 142 receives an aforementioned request for storage location from a server 20, it sends an instruction for transfer to the PCIe switch 51 to switch the destination to output the file to the server 20 that sent the request for storage location.

If the determination at Step 401 is that no entry of the job input/output management table 141 exists in which the file name 1412 indicates the file included in the request for destination and the output server 1413 indicates the server 20 included in the request for destination among the entries in which the information types 1411 indicate user-registered information, the file operator 142 determines, like in the first embodiment, whether any entry of the job input/output management table 141 exists in which the file name 1412 indicates the file included in the request for destination and the output server 1413 indicates the server 20 included in the request for destination among the entries in which the information types 1411 indicate history information (403).

If the determination at Step 403 is that an entry of the job input/ output management table 141 exists in which the file name 1412 indicates the file included in the request for destination and the output server 1413 indicates the server 20 included in the request for destination among the entries in which the information types 1411 indicate history information, the file operator 142 performs history information analysis (404). The history information analysis in the second embodiment is the same as the history information analysis in the first embodiment.

After Step 404, the file operator 142 sends an instruction for transfer including the identifier identifying the determined destination and the identifier identifying the file to be transferred to the PCIe switch 51. Upon receipt of the instruction for transfer, the PCIe switch 51 switches the ownership of the file stored in the SSD 50 to the destination server 20 designated by the received instruction for transfer (405). As a result, the file output by the job 26 is acquired by the destination server 20.

Further at Step 405, the memory data manager 15 stores, like at the Step 305 in the first embodiment, the identifier identifying the file for which the destination has been determined to the file name 1521 in the data location management table 152 and the identifier identifying the destination server 20 to the location 1522 in the data location management table 152.

If the determination at Step 403 is that no entry of the job input/output management table 141 exists in which the file name 1412 indicates the file included in the request for destination and the output server 1413 indicates the server 20 included in the request for destination among the entries in which the information types 1411 indicate history information, the file operator 142 selects a server 20 in accordance with a policy predetermined by the administrator or a user (406).

This is because, in the second embodiment, the file does not need to be output to a server 20 having a low-usage memory 22 since the memories 22 do not store files. The second embodiment can employ any policy as far as one of the servers 20 can be selected.

After Step 406, the file operator 142 determines the selected server 20 to be the destination of the file. The file operator 142 sends an instruction for transfer including the identifier identifying the determined destination and the identifier identifying the file to be transferred to the PCIe switch 51. Upon receipt of the instruction for transfer, the PCIe switch 51 switches the ownership of the file stored in the SSD 50 to the destination server 20 designated by the received instruction for transfer (407).

Further at Step 407, the memory data manager 15 acquires the identifier identifying the destination of the file from the file operator 142. Then, it stores the identifier identifying the transferred file to the file name 1521 in the data location management table 152 and the identifier identifying the destination server 20 to the location 1522 in the data location management table 152.

The second embodiment uses the SSD 50 capable of high-speed processing, enabling a file output by a job 26 of a preceding job to be input to a job 26 of a subsequent job without degrading the performance of the disk device. Furthermore, the second embodiment can reduce the load to the memories 22 since the servers 20 store the files output by the jobs 26 to the SSD 50.

### Third Embodiment

The computer system of the third embodiment uses a job schedule management server to input a transferred file to a job 26 at the destination of the file, even if the destination of the file cannot be determined with reference to the job input/output management table 141. As a result, it can prevent the transferred file from tightening the memories 22.

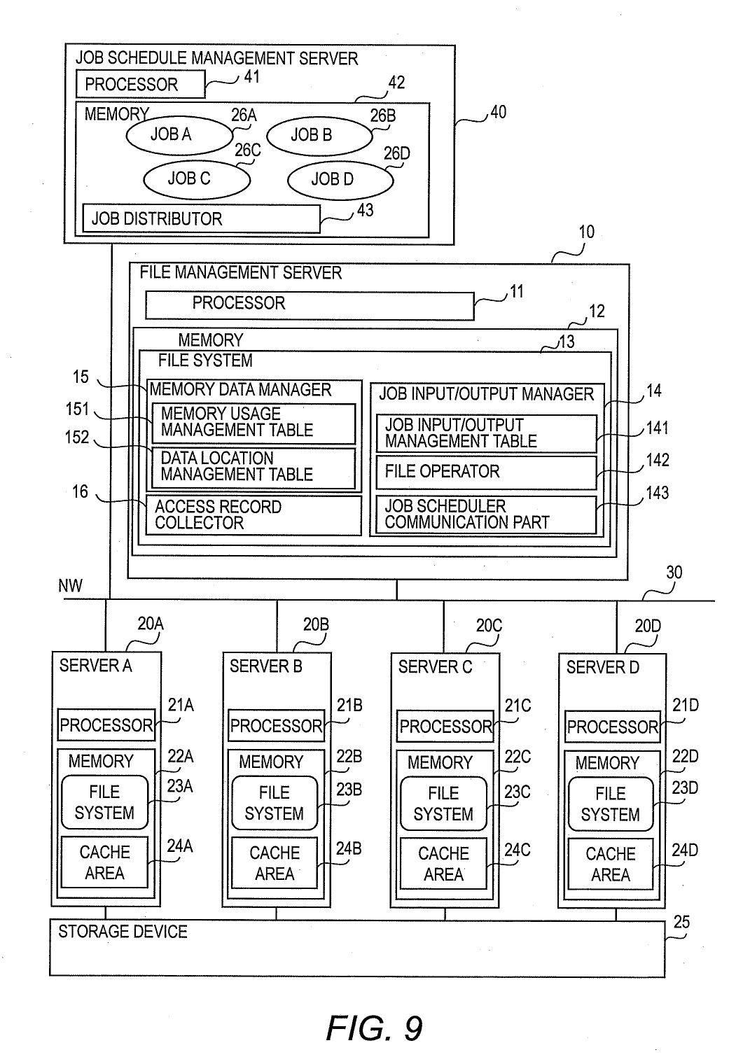

FIG. 9 is a block diagram illustrating a physical configuration of the computer system in the third embodiment of this invention.

The computer system in the third embodiment includes a file management server 10 and a plurality of servers 20 (20A to 20D) like in the first embodiment. The file management server 10 and the servers 20 are connected by a network 30.

The computer system in the third embodiment further includes a job schedule management server 40. The job schedule management server 40 is a computer and is a server for sending a server 20 to execute a job 26 a request to execute the job 26.

The job schedule management server 40 includes a processor 41 and a memory 42. It further includes a not-shown network interface. The memory 42 includes a job distributor 43 and a plurality of jobs 26 (26A to 26D).

The job distributor 43 is a program for sending a job 26 and a request to execute the job 26 to a server 20 in accordance with a request sent from the file management server 10. Each job 26 includes a program and parameters to be used by the program, like in the first embodiment.

The memory 42 holds identifiers for identifying the jobs 26 and identifiers for identifying the files to be input to the jobs 26. Hence, upon receipt of an identifier designating the destination of a file and the identifier designating the file from the file management server 10, the job distributor 43 can acquire the job to which the file identified by a received identifier is input and request the destination of the file to execute the acquired job.

It should be noted that the jobs 26 shown in FIG. 9 may be stored in a secondary storage device and loaded to the memory 42 as necessary.

The file management server 10 in the third embodiment has the same functions as the file management server 10 in the first embodiment. The file management server 10 in the third embodiment further includes a job scheduler communication part 143 in the memory 12.

The job scheduler communication part 143 is a program to be called up by the job input/output manager 14. The job scheduler communication part 143 is a program for notifying the job schedule management server 40 of which server a file is transferred to.

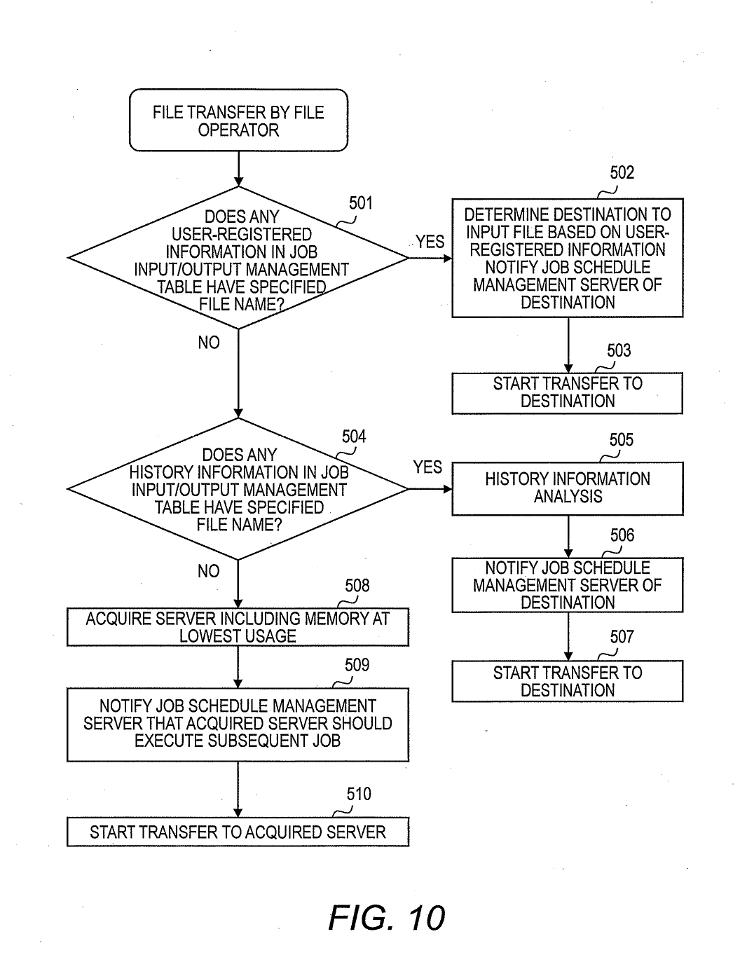

FIG. 10 is a flowchart illustrating file transfer performed by the file operator 142 and the job scheduler communication part 143 in the third embodiment of this invention.

In each server 20 in the third embodiment, the file system 23 stores a file output by a job 26 to the cache area 24 of the server 20 that executed the job 26 after execution of the job 26 in accordance with a request for execution from the job schedule management server 40. Then, like the file system 23 in the first embodiment, it sends a request for destination and the usage of the memory 22 to the file management server 10 in order to inquire where to transfer the output file.

Upon receipt of a request for destination from a server 20, the file management server 10 in the third embodiment starts the processing of the file management server 10 illustrated in FIG. 10. First, the file operator 142 in the third embodiment that has received a request for destination from the server 20 determines, like the file operator 142 in the first embodiment, whether any entry of the job input/output management table 141 exists in which the file name 1412 indicates the file included in the request for destination and the output server 1413 indicates the server 20 included in the request for destination among the entries in which the information types 1411 indicate user-registered information (501).

If the determination at Step 501 is that an entry of the job input/output management table 141 exists in which the file name 1412 indicates the file included in the request for destination and the output server 1413 indicates the server 20 included in the request for destination among the entries in which the information types 1411 indicate user-registered information, the file operator 142 determines the server 20 indicated by the input server 1414 of the entry representing the file included in the request for destination to be the destination.

The job scheduler communication part 143 in the third embodiment then sends a request for job scheduling including the identifier identifying the determined destination and the identifier identifying the file to be transferred to the job schedule management server 40.

Upon receipt of the identifier identifying the determined destination and the identifier identifying the file to be transferred, the job distributor 43 in the job schedule management server 40 acquires the job 26 to input the file identified by the received identifier and sends a request for execution to the determined destination in order to request to execute the acquired job 26. The request for execution includes the job 26 to input the file (502).

After Step 502, the file operator 142 sends an instruction for transfer including the identifier identifying the determined destination and the identifier identifying the file to be transferred to the server 20 that sent the request for destination. Upon receipt of the instruction for transfer, the file system 23 of the server 20 transfers the file stored in the cache area 24 to the destination server 20 designated by the received instruction for transfer (503).

Further at Step 503, the memory data manager 15 acquires the identifier identifying the destination of the file from the file operator 142. Then, it extracts an entry of the data location management table 152 that includes the identifier identifying the transferred file in the file name 1521 and updates the location 1522 of the extracted entry with the identifier identifying the destination server 20.

If the determination at Step 501 is that no entry of the job input/output management table 141 exists in which the file name 1412 indicates the file included in the request for destination and the output server 1413 indicates the server 20 included in the request for destination among the entries in which the information types 1411 indicate user-registered information, the file operator 142 determines whether any entry of the job input/output management table 141 exists in which the file name 1412 indicates the file included in the request for destination and the output. server 1413 indicates the server 20 included in the request for destination among the entries in which the information types 1411 indicate history information (504).

If the determination at Step 504 is that an entry of the job input/output management table 141 exists in which the file name 1412 indicates the file included in the request for destination and the output server 1413 indicates the server 20 included in the request for destination among the entries in which the information types 1411 indicate history information, the file operator 142 performs history information analysis (505). The history information analysis in the third embodiment is the same as the history information analysis in the first embodiment.

After Step 505, the job scheduler communication part 143 sends a request for job scheduling including the identifier identifying the determined destination and the identifier identifying the file to be transferred to the job schedule management server 40.

Upon receipt of the identifier identifying the determined destination and the identifier identifying the file to be transferred, the job distributor 43 in the job schedule management server 40 acquires the job 26 to input the file identified by the received identifier and sends a request for execution to the determined destination in order to request to execute the acquired job 26. The request for execution includes the job 26 to input the file (506).

After Step 506, the file operator 142 sends an instruction for transfer including the identifier identifying the determined destination and the identifier identifying the file to be transferred to the server 20 that sent the request for destination. Upon receipt of the instruction for transfer, the file system 23 in the server 20 transfers the file stored in the cache area 24 to the destination server 20 designated by the received instruction for transfer (507).

Further at Step 507, the memory data manager 15 acquires the identifier identifying the destination of the file from the file operator 142. Then, it extracts an entry of the data location management table 152 including the identifier identifying the transferred file in the file name 1521 and updates the location 1522 of the extracted entry with the identifier of the destination server 20.

If the determination at Step 504 is that no entry of the job input/output management table 141 exists in which the file name 1412 indicates the file included in the request for destination and the output server 1413 indicates the server 20 included in the request for destination among the entries in which the information types 1411 indicate history information, the file operator 142 refers to the memory usage management table 151 and acquires a value of the server 1511 of the entry in which the memory usage 1512 indicates the lowest value (508).

After Step 508, the job scheduler communication part 143 sends a request for job scheduling including the value of the server 1511 acquired at Step 508 as the identifier identifying the determined destination to the job schedule management server 40. The job scheduler communication part 143 further includes the identifier identifying the file to be transferred included in the request for destination in the request for job scheduling (509).

Upon receipt of the identifier identifying the determined destination and the identifier identifying the file to be transferred, the job distributor 43 in the job schedule management server 40 acquires the job 26 to input the file identified by the received identifier and requests the determined destination to execute the acquired job 26.

After Step 509, the file operator 142 sends an instruction for transfer including the identifier identifying the determined destination and the identifier identifying the file to be transferred to the server 20 that sent the request for destination. Upon receipt of the instruction for transfer, the file system 23 of the server 20 transfers the file stored in the cache area 24 to the destination server 20 in accordance with the received instruction for transfer (510).

Further at Step 510, the memory data manager 15 acquires the identifier identifying the destination of the file from the file operator 142. Then, it extracts an entry of the data location management table 152 including the identifier identifying the transferred file in the file name 1521 and updates the location 1522 of the extracted entry with the identifier of the destination server 20.

In the case where the file is transferred to a server having a low usage memory 22, the job schedule management server 40 sends a request to execute the job 26 to the destination of the file; the transferred file is input to the job 26 at the destination server 20. Accordingly, the computer system in the third embodiment can prevent the memory 22 from becoming tight by a file for which the destination cannot be determined with the job input/output management table 141.

The third embodiment can eliminate increase in usages of the memories 22 because of a file for which the destination cannot be determined with the job input/output management table 141 by employing the job schedule management server 40. Furthermore, the third embodiment can prevent degradation in processing performance of the disk device by no use of the disk device in transferring a file output by a job 26.

It should be noted that the computer system in the third embodiment and the computer system in the second embodiment may be implemented in a single computer system. Specifically, the computer system in the second embodiment may include a job schedule management server 40 and the file management server 10 in the second embodiment may have a job scheduler communication part 143.

When the file operator 142 in the second embodiment sends an instruction for transfer including the identifier identifying the determined destination and the identifier identifying the file to be transferred to the PCIe switch 5, the job scheduler communication part 143 may send a request for job scheduling including the determined destination to the job schedule management server 40.

In the foregoing embodiments, the file management server 10, the servers 20, and the job schedule management server 40 are implemented in physically separate computers; however, they may be implemented in virtually separated computers made of at least one each of processor and memory.

The foregoing embodiments transfer a file output by a job 26 of the preceding job to a server 20 to execute a job 26 of the subsequent job without using the disk device. For this reason, the performance of the disk device is not degraded.

If the destination of a file cannot be determined with reference to the job input/output management table 141, the file is stored in a low usage memory 22 or an SSD 50 separate from the memories 22. Accordingly, the computer systems of the embodiments can prevent the memories 22 from becoming tight. Furthermore, the job schedule management server 40 schedules to execute a file at a destination server 20; increase in usages of the memories 22 can be prevented.

The computer systems in the embodiments can transfer a file to be accessed from a plurality of servers 20 to a server 20 which is most likely to need the file as input data by holding the job input/output management table 141.

As set forth above, this invention has been described in detail with reference to the accompanying drawings; however, this invention is not limited to these specific configurations but include various modification and equivalent configurations within the scope of the attached claims.

The systems in the embodiments can be applied to cluster systems that make a plurality of computers execute jobs.

1. A computer system comprising:
a plurality of execution servers; and
a management server connected with the plurality of execution servers via a network,
wherein each of the plurality of execution servers includes a processor and a network interface,
wherein each of the plurality of execution servers stores pieces of data output by executing jobs to a storage device including semiconductor memory elements,
wherein the plurality of execution servers includes a first execution server,
wherein the management server includes a processor, a memory, and a network interface,
wherein the management server holds input/output information including identifiers identifying pieces of data, identifiers identifying execution servers which output the pieces of data, and identifiers identifying execution servers to execute jobs to which the pieces of data are input in the memory of the management server,
wherein the first execution server sends a request for destination including an identifier identifying the first execution server and an identifier identifying a first piece of data, which is output by executing a job in the first execution server to the management server in order to inquire where to transfer the first piece of data,
wherein the management server which has received the request for destination determines an execution server to execute a job to which the first piece of data is input to be a destination execution server of the first piece of data based on the input/output information and the received request for destination, and
wherein the management server outputs an instruction for transfer including an identifier identifying the determined destination execution server and the identifier identifying the first piece of data in order to transfer the first piece of data from the storage device holding the first piece of data to the determined destination execution server.

2. The computer system according to claim 1,
wherein the management server acquires history records each including a number of accesses and a time of access from the plurality of execution servers to a piece of data from the plurality of execution servers,
wherein the management server includes the acquired history records in the input/output information,
wherein, upon receipt of the request for destination, the management server determines whether the input/output information includes a plurality of identifiers identifying second execution servers to execute a job to which the first piece of data is input,
wherein, in a case where a result of the determination is that the input/output information includes a plurality of identifiers identifying the second execution servers, the management server determines whether the input/output information includes an identifier identifying a third execution server, which is one of the second execution servers and accessed the first piece of data the latest and later than a predetermined time after a time of access from another second execution server to the first piece of data, in the plurality of identifiers identifying the second execution servers,
wherein, in a case where a result of the determination is that the input/output information does not include the identifier identifying the third execution server, the management server determines whether the input/output information includes an identifier identifying a fourth execution server, which is one of the second execution servers and accessed the first piece of data the most frequently and more frequently than another second execution server by a predetermined number of times or more, in the plurality of identifiers identifying the second execution servers, and
wherein, in a case where a result of the determination is that the input/output information includes the identifier identifying the fourth execution server, the management server determines the fourth execution server to be the destination execution server of the first piece of data.

3. A computer system according to claim 2,
wherein the management server collects memory usages of the plurality of execution servers,
wherein the management server stores memory information including identifiers identifying the plurality of execution servers from which the memory usages are collected and the collected memory usages in the memory of the management server,
wherein, in a case where a result of the determination is that the input/output information does not include an identifier identifying the fourth execution server, the management server selects an execution server showing a lowest memory usage with reference to the memory information, and
wherein the management server determines the selected execution server to be the destination execution server of the first piece of data.

4. A computer system according to claim 1,
wherein each of the plurality of execution servers executes a file system with the processor,
wherein each of the plurality of execution servers inputs and outputs the pieces of data as files with the file system, and
wherein the management server holds input/output information including identifiers identifying the files, identifiers identifying the execution servers, and identifiers identifying the execution servers to execute the jobs to which the files are input.

5. A computer system according to claim 1, further comprising a PCIe switch,
wherein the management server is connected with the PCIe switch,
wherein each of the plurality of execution servers is connected with the storage device via the PCIe switch,
wherein the first execution server outputs the first piece of data output by executing a job to the storage device via the PCIe switch,
wherein the management server outputs the instruction for transfer to the PCIe switch, and
wherein the PCIe switch switches where to output the first piece of data in accordance with the instruction for transfer.

6. A computer system according to claim 1, further comprising a job schedule server including data for executing the jobs,
wherein the management server and the plurality of execution servers are connected with the job schedule server via the network,
wherein the management server outputs the instruction for transfer to the job schedule server and the first execution server,
wherein the job schedule server sends data for executing the job to which the first piece of data is input to the determined execution server in accordance with the instruction for transfer, and
wherein the first execution server transfers the first piece of data from the storage device to which the first piece of data is output to the determined execution server in accordance with the instruction for transfer.

7. A data transfer method performed by a computer system,
the computer system including a plurality of execution servers and a management server connected with the execution servers via a network,
each of the plurality of execution servers including a processor and a network interface and storing pieces of data output by executing jobs to a storage device including semiconductor memory elements,
the plurality of execution servers including a first execution server,
the management server including a processor, a memory, and a network interface and holding input/output information including identifiers identifying pieces of data, identifiers identifying execution servers which output the pieces of data, and identifiers identifying execution servers to execute jobs to which the pieces of data are input in the memory of the management server,
the data transfer method comprising:
a step of sending, by the first execution server, a request for destination including an identifier identifying the first execution server and an identifier identifying a first piece of data, which is output by executing a job in the first execution server, to the management server in order to inquire where to transfer the first piece of data,
a step of determining, by the management server which has received the request for destination, an execution server to execute a job to which the first piece of data is input to be a destination execution server of the first piece of data based on the input/output information and the received request for destination, and
a step of outputting, by the management server, an instruction for transfer including an identifier identifying the determined destination execution server and the identifier identifying the first piece of data in order to transfer the first piece of data from the storage device holding the first piece of data to the determined destination execution server.

8. A data transfer method according to claim 7, further comprising:
a step of acquiring, by the management server, history records each including a number of accesses and a time of access from the plurality of execution servers to a piece of data from the plurality of execution servers; and
a step of including, by the management server, the acquired history records in the input/output information,
wherein the step of determining a destination execution server of the first piece of data includes:
a step of determining, by the management server, whether the input/output information includes a plurality of identifiers identifying second execution servers to execute a job to which the first piece of data is input upon receipt of the request for destination;
a step of determining, by the management server, whether the input/output information includes an identifier identifying a third execution server, which is one of the second execution servers and accessed the first piece of data the latest and later than a predetermined time after a time of access from another second execution server to the first piece of data, in a plurality of identifiers identifying the second execution servers, in a case where a result of the determination is that the input/output information includes the plurality of identifiers identifying the second execution servers;
a step of determining, by the management server, whether the input/output information includes an identifier identifying a fourth execution server, which is one of the second execution servers and accessed the first piece of data the most frequently and more frequently than another second execution server by a predetermined number of times or more, in the plurality of identifiers identifying the second execution servers, in a case where a result of the determination is that the input/output information does not include the identifier identifying the third execution server; and
a step of determining, by the management server, the fourth execution server to be the destination execution server of the first piece of data in a case where a result of the determination is that the input/output information includes the identifier identifying the fourth execution server.

9. A data transfer method according to claim 8, further comprising:
a step of collecting, by the management server, memory usages of the plurality of execution servers; and
a step of storing, by the management server, memory information including identifiers identifying the plurality of execution servers from which the memory usages are collected and the collected memory usages in the memory of the management server,
wherein the step of determining a destination execution server of the first piece of data includes:
a step of selecting, by the management server, an execution server showing a lowest memory usage with reference to the memory information in a case where a result of the determination is that the input/output information does not include an identifier identifying the fourth execution server; and
a step of determining, by the management server, the selected execution server to be the destination execution server of the first piece of data.

10. A data transfer method according to claim 7,
wherein each of the plurality of execution servers executes a file system with the processor,
wherein each of the plurality of execution servers inputs and outputs the pieces of data as files with the file system, and
wherein the data transfer method further comprises a step of holding, by the management server, input/output information including identifiers identifying the files, identifiers identifying the execution servers, and identifiers identifying the execution servers to execute the jobs to which the files are input.

11. A data transfer method according to claim 7,
wherein the computer system further includes a PCIe switch,
wherein the management server is connected with the PCIe switch,
wherein each of the plurality of execution servers is connected with the storage device via the PCIe switch,
wherein storing the pieces of data output to the storage device includes a step of outputting, by the first execution server, the first piece of data output by executing the job to the storage device via the PCIe switch,
wherein the step of outputting an instruction for transfer includes a step of outputting, by the management server, the instruction for transfer to the PCIe switch, and
wherein the data transfer method further comprises a step of switching, by the PCIe switch, where to output the first piece of data in accordance with the instruction for transfer.

12. A data transfer method according to claim 7,
wherein the computer system further includes a job schedule server including data for executing the jobs,
wherein the management server and the plurality of execution servers are connected with the job schedule server via the network,
wherein the step of outputting an instruction for transfer includes a step of outputting, by the management server, the instruction for transfer to the job schedule server and the first execution server, and
wherein the data transfer method further comprises:
a step of sending, by the job schedule server, data for executing the job to which the first piece of data is input to the determined execution server in accordance with the instruction for transfer; and
a step of transferring, by the first execution server, the first piece of data from the storage device to which the first piece of data is output to the determined execution server in accordance with the instruction for transfer.

13. A non-transitory computer readable storage medium for storing a data transfer program, which, when executed on a management server, causes the management server to perform processing,
the management server being connected with a plurality of execution servers for storing pieces of data output by executing jobs to a storage device including semiconductor memory elements via a network, including a processor, a memory, and a network interface, and holding input/output information including identifiers identifying the pieces of data, identifiers identifying execution servers which output the pieces of data, and identifiers identifying execution servers to execute jobs to the pieces of data are input in the memory of the management server,
the data transfer program causing the management server to perform:
a step of receiving, from the first execution server, a request for destination including an identifier identifying the first execution server and an identifier identifying a first piece of data, which is output by executing a job in the first execution server, in order to inquire where to transfer the first piece of data;
a step of determining an execution server to execute a job to which the first piece of data is input to be a destination execution server of the first piece of data based on the input/output information and the received request for destination upon receipt of the request for destination; and
a step of outputting an instruction for transfer including an identifier identifying the determined destination execution server and the identifier identifying the first piece of data in order to transfer the first piece of data from the storage device holding the first piece of data to the determined destination execution server.

14. A non-transitory computer readable storage medium according to claim 13, the data transfer program causing the management server to further perform:
a step of acquiring history records each including a number of accesses and a time of access from the plurality of execution servers to a piece of data from the plurality of execution servers; and
a step of including the acquired history records in the input/output information,
wherein the step of determining a destination execution server of the first piece of data includes:
a step of determining whether the input/output information includes a plurality of identifiers identifying second execution servers to execute a job to which the first piece of data is input upon receipt of the request for destination;
a step of determining whether the input/output information includes an identifier identifying a third execution server, which is one of the second execution servers and accessed the first piece of data the latest and later than a predetermined time after a time of access from another second execution server to the first piece of data, in a plurality of identifiers identifying the second execution servers, in a case where a result of the determination is that the plurality of identifiers identifying the second execution servers;
a step of determining whether the input/output information includes an identifier identifying a fourth execution server, which is one of the second execution servers and accessed the first piece of data the most frequently and more frequently than another second execution server by a predetermined number of times or more, in the plurality of identifiers identifying the second execution servers, in a case where a result of the determination is that the input/output information does not include the identifier identifying the third execution server; and
a step of determining the fourth execution server to be the destination execution server of the first piece of data in a case where a result of the determination is that the input/output information includes the identifier identifying the fourth execution server.

15. A non-transitory computer readable storage medium according to claim 14, the data transfer program causing the management server to further perform:
a step of collecting usages of the memories of the execution servers; and
a step of storing memory information including identifiers identifying execution servers from which the usages of the memories are collected and the collected usages of the memories in the memory of the management server,
wherein the step of determining an execution server where to transfer the first piece of data includes:
a step of selecting an execution server including the memory having the lowest usage from the memory information in a case where a result of the determination is that the input/output information does not include the identifier identifying the fourth execution server; and
a step of determining the selected execution server to be the execution server where to transfer the first piece of data.

16. A non-transitory computer readable storage medium according to claim 13,
wherein each of the execution servers executes a file system with the processor,
wherein each of the execution servers inputs and outputs the pieces of data as files with the file system, and
wherein the management server holds input/output information including identifiers identifying the files, identifiers identifying the execution servers, and identifiers identifying execution servers to execute jobs to which the files are input.

17. A non-transitory computer readable storage medium according to claim 13,
wherein the management computer is connected with a PCIe switch,
wherein each of the plurality of execution servers is connected with the storage device via the PCIe switch, and
wherein the step of outputting the instruction for transfer includes a step of outputting the instruction for transfer to the PCIe switch in order to switch where to output the first piece of data in accordance with the instruction for transfer.

18. A non-transitory computer readable storage medium according to claim 13,
wherein the management server and the plurality of execution servers are connected with a job schedule server including data for executing the jobs via the network, and
wherein the step of outputting an instruction for transfer includes a step of outputting the instruction for transfer to the job schedule server and the first execution server in order for the job schedule server to send data for executing the job to which the first piece of data is input to the determined execution server in accordance with the instruction for transfer and for the first execution server to transfer the first piece of data from the storage device to which the first piece of data is output to the determined execution server in accordance with the instruction for transfer.
